(19) United States
(12) Patent Application Publication
(10) Pub. No.: US 2026/0223828 A1
(43) Pub. Date: Aug. 6, 2026

(54) FISHING ROD HOLDER DEVICE

(71) Applicant: James Michalowski, Port St. Lucie, FL (US)

(72) Inventor: James Michalowski, Port St. Lucie, FL (US)

(21) Appl. No.: 19/047,107

(22) Filed: Feb. 6, 2025

(51) Int. Cl. A01K 97/10; A47B 81/00; B63B 17/00; B63B 45/04

(52) U.S. Cl. CPC A01K 97/10; A47B 81/005; B63B 17/00; B63B 45/04

(57) ABSTRACT

A fishing rod holder device includes a boat that has a pair of poles and a floor. A lower strap is extendable around the pair of poles and a plurality of cups is coupled to the lower strap insertably receive a handle of a respective one of a plurality of fishing rods. An upper strap is extendable around the pair of poles in the boat and a plurality of fishing rod straps is coupled to the upper strap for wrapping around a respective one of the plurality of fishing rods to secure the respective one of the plurality of fishing rods to the upper strap. A plurality of lights is each coupled to a respective one of a plurality of light housings. A plurality of clips is each coupled to a respective light housing to retain a respective light housings to a respective one of the upper strap or the lower strap.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to fishing rod devices and more particularly pertains to a new fishing rod device for securing fishing rods in vertical orientation on a boat. The device includes a lower strap that can be wrapped around a pair of pole of the boat and a plurality of cups attached to the lower strap for insertably receiving a handle of a fishing pole. The device includes an upper strap that can be wrapped around the pair of poles and a plurality of fishing pole straps each coupled to the upper strap. Each of the fishing pole straps can be wrapped around a respective fishing pole to retain the respective fishing pole in a vertical orientation. The device includes a plurality of light housings and a plurality of lights each attached to a respective light housing. The device includes a plurality of clips each coupled to respective light housing for securing the respective light housing to a respective upper strap or lower strap.

### (2) Description of Related Art Including Information Disclosed Under 37 CFR 1.97 and 1.98

The prior art relates to fishing rod devices including: a variety of portable fishing rod holders that each at least includes a plurality of tubes that can insertably receive a handle of a fishing pole which are each attached to a rigid structural element; a fishing pole storage system that includes a rack that has a plurality slots and a plurality of holes for insertably receiving a fishing pole. In no instance does the prior art disclose a fishing rod holder device that includes a lower strap that can be wrapped around a pair of poles of a boat and a plurality of cups attached to the lower strap for insertably receiving a handle of a fishing pole and an upper strap that can be wrapped around the pair of poles of the boat and a plurality of fishing rod straps each coupled to the upper strap which can be wrapped around a fishing pole.

### (h) BRIEF SUMMARY OF THE INVENTION

An embodiment of the disclosure meets the needs presented above by generally comprising a boat that has a pair of poles and a floor. A lower strap is extendable around the pair of poles and a plurality of cups is coupled to the lower strap insertably receive a handle of a respective one of a plurality of fishing rods. An upper strap is extendable around the pair of poles in the boat and a plurality of fishing rod straps is coupled to the upper strap for wrapping around a respective one of the plurality of fishing rods to secure the respective one of the plurality of fishing rods to the upper strap. A plurality of lights is each coupled to a respective one of a plurality of light housings. A plurality of clips is each coupled to a respective light housing to retain a respective light housings to a respective one of the upper strap or the lower strap.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a fishing rod holder device according to an embodiment of the disclosure.

FIG. 2 is a back perspective view of a lower strap of an embodiment of the disclosure.

FIG. 3 is a front perspective view of a light housing of an embodiment of the disclosure.

FIG. 4 is a back perspective view of a light housing of an embodiment of the disclosure.

FIG. 5 is a perspective in-use view of an embodiment of the disclosure.

FIG. 6 is a cross sectional view taken along line 6 -6 of FIG. 5 of an embodiment of the disclosure.

### (J) DETAILED DESCRIPTION OF THE INVENTION

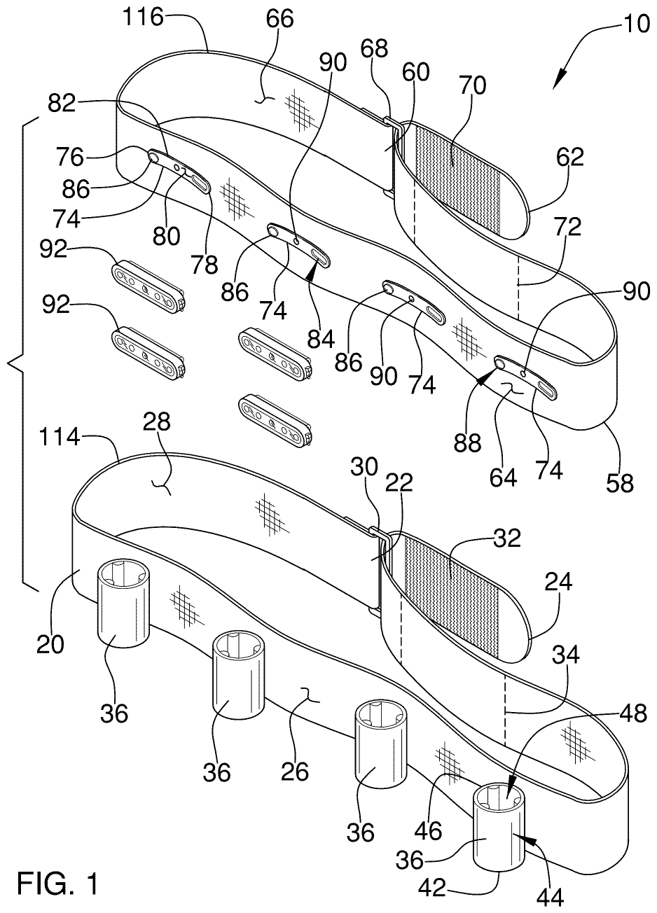

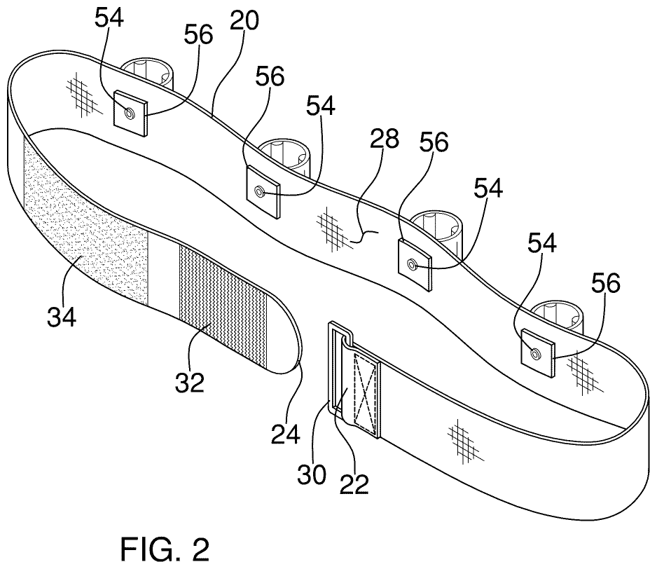

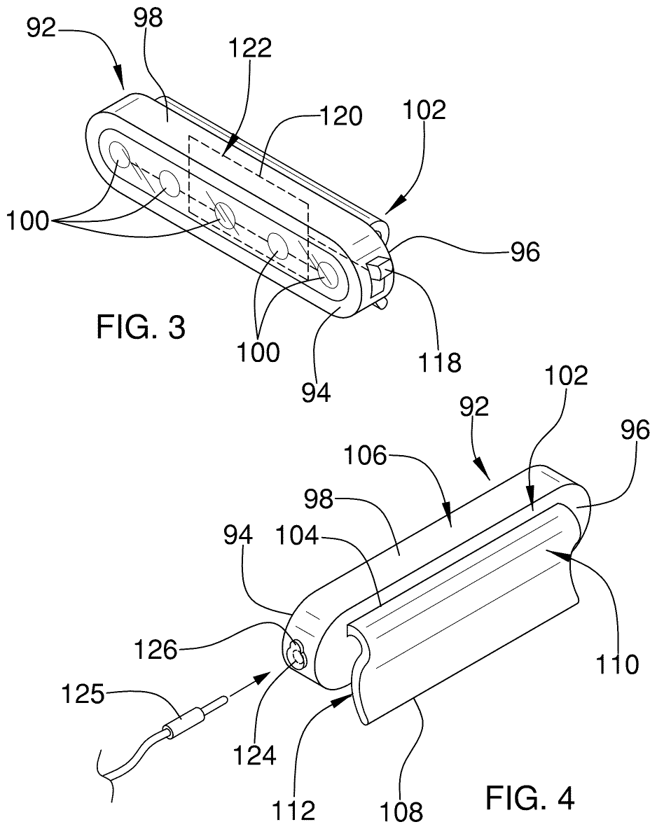

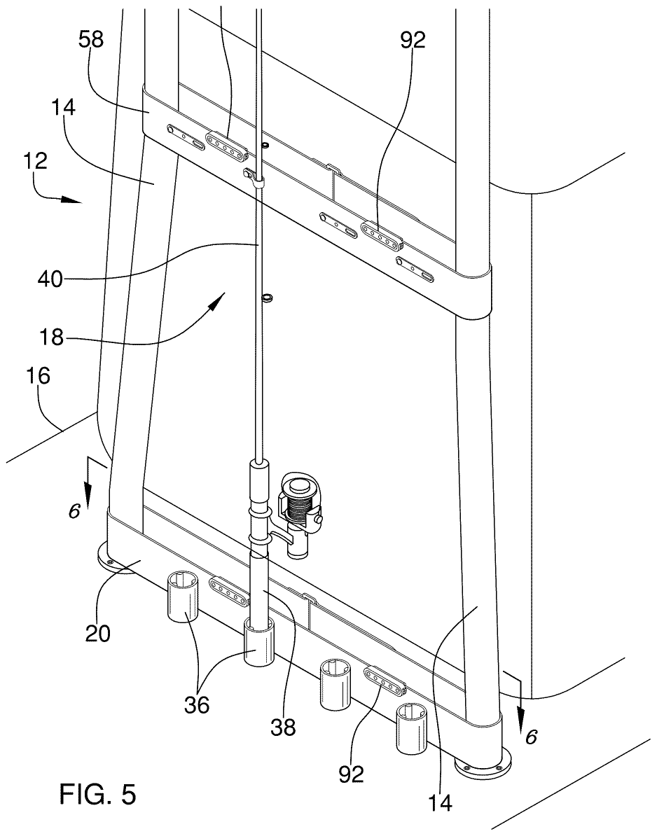

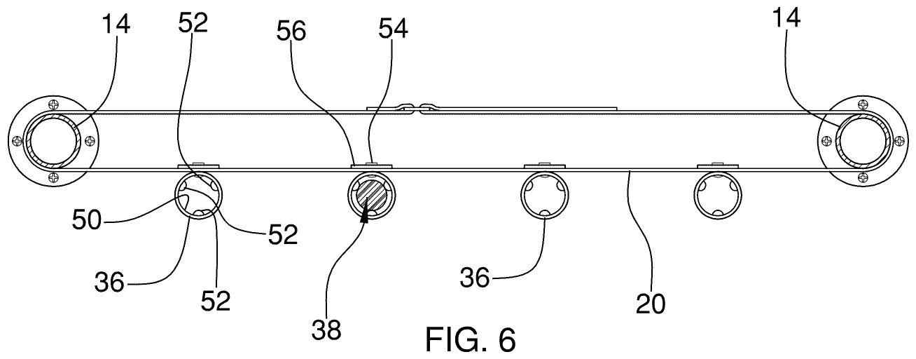

With reference now to the drawings, and in particular to FIGS. 1 through 6 thereof, a new fishing rod device embodying the principles and concepts of an embodiment of the disclosure and generally designated by the reference numeral 10 will be described.

As best illustrated in FIGS. 1 through 6, the fishing rod holder device 10 generally comprises a boat 12 that has a pair of poles 14 and a floor 16. Each pole 14 of the pair of poles 14 is coupled to and extends upwardly from the floor 16 and each pole 14 of the pair of poles 14 is vertically oriented. The boat 12 may be a center console boat, for example, or other type of freshwater fishing boat or saltwater fishing boat. Furthermore, the pair of poles 14 may be positioned on opposite sides of a center console 18 of the boat 12.

A lower strap 20 is extendable around the pair of poles 14 and the lower strap 20 is releasably matable to itself. Furthermore, the lower strap 20 forms a closed loop extending around the pair of poles 14 when the lower strap 20 is releasably mated to itself. The lower strap 20 is positionable adjacent to the floor 16 of the boat 12. The lower strap 20 has a first end 22 and a second end 24; the lower strap 20 has a front surface 26 extending between the first end 22 and the second end 24; the lower strap 20 has a back surface 28 extending between the first end 22 and the second end 24.

A lower buckle 30 is coupled to the first end 22 of the lower strap 20 and the second end 24 of the lower strap 20 is extendable through the lower buckle 30. The lower buckle 30 may be comprised of a rigid and corrosion resistant material, including but not being limited stainless steel or titanium, such that the lower buckle 30 resists being corroded by exposure to freshwater or saltwater. A first lower mating member 32 is coupled to the front surface 26 of the lower strap 20 and the first lower mating member 32 is located adjacent to the second end 24 of the lower strap 20. A second lower mating member 34 is coupled to the front surface 26 of the lower strap 20 and the second lower mating member 34 is located between the first lower mating member 32 and the first end 22 of the lower strap 20. The first lower mating member 32 is releasably matable to the second lower mating member 34 when the second end 24 of the lower strap 20 is extended through the lower buckle 30. Each of the first lower mating member 32 and the second lower mating member 34 may comprise complementary portions of a hook and loop fastener or other type of multiple use, releasable fastener that is impervious to corrosion caused by exposure to either freshwater or saltwater.

A plurality of cups 36 is each coupled to the lower strap 20 and each cup 36 of the plurality of cups 36 can insertably receive a handle 38 of a respective one of a plurality of fishing rods 40. Each cup 36 of the plurality of cups 36 lies on the floor 16 of the boat 12 when the lower strap 20 is secured around the pair of poles 14 to orient the respective fishing rod 40 in a vertical orientation. Each cup 36 of the plurality of cups 36 has a bottom wall 42 and an outer wall 44 extending upwardly from the bottom wall 42. The outer wall 44 of each cup 36 of the plurality of cups 36 has a top edge 46 and the top edge 46 of the outer wall 44 of a respective one of the plurality of cups 36 defines an opening 48 into the respective one of the plurality of cups 36 to receive the handle 38 of the respective fishing rod 40. Each cup 36 of the plurality of cups 36 may be comprised of a corrosion resistant material, including but not being limited to rubber of polyvinylchloride, such that the plurality of cups 36 resists being corroded by exposure to freshwater or saltwater.

The outer wall 44 of each cup 36 of the plurality of cups 36 has an interior surface 50. Additionally, the outer wall 44 of each cup 36 of the plurality of cups 36 has a plurality of protrusions 52 which each extends away from the interior surface 50. The plurality of protrusions 52 associated with a respective one of the plurality of cups 36 is evenly spaced apart from each other and is distributed around a full circumference of the interior surface 50. Furthermore, the plurality of protrusions 52 associated with the respective one of the plurality of cups 36 abuts against the handle 38 of the respective fishing rod 40 for securing the handle 38 of the respective fishing rod 40 in the respective one of the plurality of cups 36. Each protrusion 52 of the plurality of protrusions 52 associated with a respective one of the plurality of cups 36 extends between the bottom wall 42 of the respective one of the plurality of cups 36 and the top edge 46 of the outer wall 44 of the respective one of the plurality of cups 36. Furthermore, each protrusion 52 of the plurality of protrusions 52 associated with the respective one of the plurality of cups 36 extends along a partial length of the handle 38 of the respective fishing rod 40 when the handle 38 of the respective fishing rod 40 is inserted into the respective one of the plurality of cups 36.

A plurality of cup fasteners 54 is provided and each cup fastener 54 of the plurality of cup fasteners 54 extends through the outer wall 44 of a respective one of the plurality of cups 36. Each cup fastener 54 of the plurality of cup fasteners 54 extends through the front surface 26 of the lower strap 20 and each cup fastener 54 of the plurality of cup fasteners 54 extends through the back surface 28 of the lower strap 20. Each of the plurality of cup fasteners 54 may be comprised of a corrosion resistant material, including but not being limited to stainless steel or titanium, such the plurality of cup fasteners 54 resists being corroded by exposure to freshwater or saltwater.

A plurality of lower strap retainers 56 is each positioned against the back surface 28 of the lower strap 20. Each cup fastener 54 of the plurality of cup fasteners 54 extends through a respective one of the plurality of lower strap retainers 56. Additionally, each cup fastener 54 of the plurality of cup fasteners 54 is coupled to the respective one of the plurality of lower strap retainers 56. Each cup fastener 54 of the plurality of cup fasteners 54 attaches a respective one of the plurality of cups 36 to a respective one of the plurality of lower strap retainers 56. Furthermore, each lower strap retainer 56 of the plurality of lower strap retainers 56 inhibits the cup fastener which extends through a respective one of the plurality of lower strap retainers 56 from being pulled through the lower strap 20. Each lower strap retainer 56 of the plurality of lower strap retainers 56 may be comprised of a corrosion resistant material, including but not being limited to rubber of polyvinylchloride, such that the plurality of lower strap retainers 56 resists being corroded by exposure to freshwater or saltwater.

An upper strap 58 is extendable around the pair of poles 14 in the boat 12 and the upper strap 58 is releasably matable to itself. The upper strap 58 forms a closed loop extending around the pair of poles 14 when the upper strap 58 is releasably mated to itself. Additionally, the upper strap 58 is spaced upwardly from the lower strap 20 on the pair of poles 14. The upper strap 58 has a primary end 60 and a secondary end 62; the upper strap 58 has a forward surface 64 extending between the primary end 60 and the secondary end 62; the upper strap 58 has a rear surface 66 extending between the primary end 60 and the secondary end 62.

An upper buckle 68 is coupled to the primary end 60 of the upper strap 58 and the secondary end 62 of the upper strap 58 is extendable through the upper buckle 68. The upper buckle 68 may be comprised of a rigid and corrosion resistant material, including but not being limited stainless steel or titanium, such that the upper buckle 68 resists being corroded by exposure to freshwater or saltwater. A first upper mating member 70 is coupled to the forward surface 64 of the upper strap 58 and the first upper mating member 70 is located adjacent to the secondary end 62 of the upper strap 58. A second upper mating member 72 is coupled to the forward surface 64 of the upper strap 58 and the second upper mating member 72 is located between the first upper mating member 70 and the primary end 60 of the upper strap 58. Furthermore, the first upper mating member 70 is releasably matable to the second upper mating member 72 when the secondary end 62 of the upper strap 58 is extended through the upper buckle 68. Each the first upper mating member 70 and the second upper mating member 72 may comprise complementary portions of a hook and loop fastener or other type of multiple user fastener that is impervious to corrosion from exposure to freshwater or saltwater.

A plurality of fishing rod straps 74 is each coupled to the upper strap 58 and each fishing rod strap 74 can be wrapped around a respective one of the plurality of fishing rods 40 to secure the respective one of the plurality of fishing rods 40 to the upper strap 58. Each fishing rod strap 74 of the plurality of fishing rod straps 74 has a coupling end 76 and a free end 78. Furthermore, each fishing rod strap 74 of the plurality of fishing rod straps 74 has a frontmost surface 80 extending between the coupling end 76 and the free end 78; each fishing rod strap 74 of the plurality of fishing rod straps 74 has a rearmost surface 82 extending between the coupling end 76 and the free end 78. Each fishing rod strap 74 of the plurality of fishing rod straps 74 may be comprised of a resiliently stretchable material, including but not being limited to rubber or silicone, which is impervious to corrosion from exposure to freshwater or salt water.

Each fishing rod strap 74 of the plurality of fishing rod straps 74 has a hole 84 extending through the frontmost surface 80 of a respective one of the plurality of fishing rod straps 74 and the rearmost surface 82 of the respective one of the plurality of fishing rod straps 74. The hole 84 associated with a respective one of the plurality of fishing rod straps 74 is located adjacent to the free end 78 of the respective one of the plurality of fishing rod straps 74. Additionally, the hole 84 associated with a respective one of the plurality of fishing rod straps 74 is elongated along an axis extending between the coupling end 76 of the respective one of the plurality of fishing rod straps 74 and the free end 78 of the respective one of the plurality of fishing rod straps 74. Subsequently, the hole 84 associated with each of the plurality of fishing rod straps 74 has an ovoid shape.

A plurality of pins 86 is provided and each pin 86 of the plurality of pins 86 is coupled to and extends away from the frontmost surface 80 of a respective one of the plurality of fishing rod straps 74. Each pin 86 of the plurality of pins 86 is located adjacent to the coupling end 76 of the respective one of the plurality of fishing rod straps 74. Additionally, each pin 86 of the plurality of pins 86 has a head 88 and the head 88 of each pin 86 of the plurality of pins 86 is spaced from the frontmost surface 80 of a respective one of the plurality of fishing rod straps 74. The head 88 of the pin 86 which is coupled to a respective one of the plurality of fishing rod straps 74 is extendable through the hole 84 in the respective one of the plurality of fishing rod straps 74. Furthermore, the respective one of the plurality of fishing rod straps 74 forms a closed loop to be secured around the respective one of the plurality of fishing rods 40.

A plurality of fishing rod strap couplers 90 is provided and each fishing rod strap coupler 90 of the plurality of fishing rod strap couplers 90 extends through the frontmost surface 80 of a respective one of the plurality of fishing rod straps 74. Additionally, each fishing rod strap coupler 90 of the plurality of fishing rod strap couplers 90 extends through the rearmost surface 82 of the respective one of the plurality of fishing rod straps 74. Each fishing rod strap coupler 90 extends through the forward surface 64 of the upper strap 58 and each fishing rod strap coupler 90 of the plurality of fishing rod strap couplers 90 extends through the rear surface 66 of the upper strap 58.

Each fishing rod strap coupler 90 of the plurality of fishing rod strap couplers 90 secures a respective one of the plurality of fishing rod straps 74 to the forward surface 64 of the upper strap 58. Additionally, each fishing rod strap coupler 90 of the plurality of fishing rod strap couplers 90 is centrally located between the coupling end 76 of a respective one of the plurality of fishing rod straps 74 and the free end 78 of the respective one of the plurality of fishing rod straps 74. The plurality of fishing rod straps 74 is evenly spaced apart from each other and is distributed between the primary end 60 and the secondary end 62 of the upper strap 58 such that each fishing rod strap 74 is aligned with a respective one of the plurality of fishing rods 40. Each fishing rod strap 74 of the plurality of fishing rod straps 74 is oriented to extend along an axis extending between the primary end 60 of the upper strap 58 and the secondary end 62 of the upper strap 58. Furthermore, each fishing rod strap 74 of the plurality of fishing rod straps 74 is oriented perpendicular to the respective one of the plurality of fishing rods 40.

A plurality of light housings 92 is provided and each light housing 92 of the plurality of light housings 92 has a front wall 94 and a rear wall 96 and an outside wall 98 extending between the front wall 94 and the rear wall 96. A plurality of lights 100 is each coupled to a respective one of the plurality of light housings 92 to emit light outwardly from the respective one of the plurality of light housings 92 for illuminating the boat 12 when the boat 12 is in a darkened environment. Each light 100 of the plurality of lights 100 is positioned on the front wall 94 of the respective one of the plurality of light housings 92. Furthermore, the plurality of lights 100 associated with a respective one of the plurality of light housings 92 is evenly spaced apart from each other and is distributed along the front wall 94 of the respective one of the plurality of light housings 92. Each light 100 of the plurality of lights 100 may comprise a light emitting diode or other type of electronic light emitter.

A plurality of clips 102 is each coupled to a respective one of the plurality of light housings 92. Additionally, each clip 102 of the plurality of clips 102 is removably attachable to a respective one of the upper strap 58 or the lower strap 20. Each clip 102 of the plurality of clips 102 retains a respective one of the plurality of light housings 92 to a respective one of the upper strap 58 or the lower strap 20. Each clip 102 of the plurality of clips 102 has a coupled end 104 which is coupled to the rear wall 96 of a respective one of the plurality of light housings 92. The outside wall 98 of each light housing 92 of the plurality of light housings 92 has a top side 106 and the coupled end 104 of each clip 102 of the plurality of clips 102 is aligned with the top side 106 of the outside wall 98 of a respective one of the plurality of light housings 92.

Each clip 102 of the plurality of clips 102 extends downwardly along the rear wall 96 of a respective one of the plurality of light housings 92. Furthermore, each clip 102 of the plurality of clips 102 has a distal end 108 with respect to the top side 106 of the outside wall 98 of a respective one of the plurality of light housings 92. Each clip 102 of the plurality of clips 102 has a first curve 110 that is located adjacent to the coupled end 104 and each clip 102 of the plurality of clips 102 has a second curve 112 that is located between the first curve 110 and the distal end 108. The first curve 110 associated with each clip 102 of the plurality of clips 102 curves outwardly from the rear wall 96 of a respective one of the plurality of light housings 92. Furthermore, the second curve 112 associated with each clip 102 of the plurality of clips 102 curves toward the rear wall 96 of a respective one of the plurality of light housings 92. The distal end 108 of each clip 102 of the plurality of clips 102 is directed away from the rear wall 96 of a respective one of the plurality of light housings 92.

The lower strap 20 has a topmost edge 114 and the topmost edge 114 is extendable between a respective one of the plurality of clips 102 on a respective one of the plurality of light housings 92 and the rear wall 96 of the respective one of the plurality of light housings 92 for retaining the respective one of the plurality of light housings 92 on the forward surface 64 of the upper strap 58. The lower strap 20 has an upper edge 116 and the upper edge 116 is extendable between a respective one of the plurality of clips 102 on a respective of the plurality of light housings 92 and the rear wall 96 of the respective one of the plurality of light housings 92 for retaining the respective one of the plurality of light housings 92 on the front surface 26 of the lower strap 20.

Each light housing 92 of the plurality of light housings 92 includes a power switch 118 and the power switch 118 on a respective one of the plurality of light housings 92 is slidably integrated into the outside wall 98 of the respective one of the plurality of light housings 92. The power switch 118 on the outside wall 98 of a respective one of the plurality of light housings 92 is in electrical communication with the plurality of lights 100 on the respective one of the plurality of light housings 92 for actuating or de-actuating the plurality of lights 100 on the respective one of the plurality of light housings 92. Each light housing 92 of the plurality of light housings 92 includes a power supply 120. The power supply 120 in a respective one of the plurality of light housings 92 is in electrical communication with the power switch 118 on the outside wall 98 of the respective one of the plurality of light housings 92.

The power supply 120 of each light housing 92 of the plurality of light housings 92 includes a rechargeable battery 122 that is positioned within a respective one of the plurality of light housings 92. In addition, the rechargeable battery 122 is in electrical communication with the power switch 118 on the outside wall 98 of the respective one of the plurality of light housings 92. The power supply 120 of each light housing 92 of the plurality of light housings 92 includes a charge port 124 which is recessed into the outside wall 98 of a respective one of the plurality of light housings 92 which can be electrically mated to a charge cord 125. The charge port 124 in the outside wall 98 of the respective one of the plurality of light housings 92 is in electrical communication with the rechargeable battery 122 in the respective one of the plurality of light housings 92 for charging rechargeable battery 122 in the respective one of the plurality of light housings 92. Additionally, the charge port 124 in the outside wall 98 of each of the light housings includes a flap 126 for covering the charge port 124 thereby protecting the charge port 124 from exposure to freshwater or saltwater.

In use, the lower strap 20 is wrapped around the pair of poles 14 such that each of the cups 36 is standing on the floor 16 of the boat 12. The upper strap 58 is wrapped around the pair of poles 14 such at point located above the lower strap 20 having each of the fishing rod straps 74 being positioned over a respective one of the cups 36. The handle 38 of a fishing rod 40 is inserted into a respective cup 36 and the fishing rod strap 74 that is aligned with the respective cup 36 is wrapped around the fishing rod 40 and secured to a respective pin 86. Furthermore, the fishing rod 40 is secured in a vertical orientation to inhibit the fishing rod 40 from tipping over or from being stepped upon. The fishing rod strap 74 that is wrapped around the fishing rod 40 is unwrapped from the fishing rod 40 and the fishing rod 40 is lifted out of the respective cup 36 to employ the fishing rod 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing rod holder device for securing a plurality of fishing rods for storage on a boat, said device comprising:
a boat having a pair of poles and a floor, each pole of said pair of poles being coupled to and extending upwardly from said floor, each pole of said pair of poles being vertically oriented;
a lower strap being extendable around said pair of poles, said lower strap being releasably matable to itself, said lower strap forming a closed loop extending around said pair of poles when said lower strap is releasably mated to itself, said lower strap being positionable adjacent to said floor of said boat;
a plurality of cups, each cup of said plurality of cups being coupled to said lower strap wherein each cup of said plurality of cups is configured to insertably receive a handle of a respective one of a plurality of fishing rods, each cup of said plurality of cups lying on said floor of said boat when said lower strap is secured around said pair of poles wherein each cup of said plurality of cups is configured to orient the respective fishing rod in a vertical orientation;
an upper strap being extendable around said pair of poles in said boat, said upper strap being releasably matable to itself, said upper strap forming a closed loop extending around said pair of poles when said upper strap is releasably mated to itself, said upper strap being spaced upwardly from said lower strap on said pair of poles;
a plurality of fishing rod straps, each fishing rod strap of said plurality of fishing rod straps being coupled to said upper strap wherein each fishing rod strap of said plurality of fishing rod straps is configured to be wrapped around a respective one of the plurality of fishing rods to secure the respective one of the plurality of fishing rods to said upper strap;
a plurality of light housings;
a plurality of lights, each light of said plurality of lights being coupled to a respective one of said plurality of light housings wherein each light of said plurality of lights is configured to emit light outwardly from said respective one of said plurality of light housings to illuminate said boat when the boat is in a darkened environment; and
a plurality of clips, each clip of said plurality of clips being coupled to a respective one of said plurality of light housings, each clip of said plurality of clips being removably attachable to a respective one of said upper strap or said lower strap, each clip of said plurality of clips retaining a respective one of said plurality of light housings to a respective one of said upper strap or said lower strap.

2. The fishing rod holder device according to claim 1, further comprising:
said lower strap having a first end and a second end;
said lower strap has a front surface extending between said first end and said second end;
said lower strap having a back surface extending between said first end and said second end;
a lower buckle being coupled to said first end of said lower strap, said second end of said lower strap being extendable through said lower buckle;
a first lower mating member being coupled to said front surface of said lower strap, said first lower mating member being located adjacent to said second end of said lower strap;
a second lower mating member being coupled to said front surface of said lower strap, said second lower mating member being located between said first lower mating member and said first end of said lower strap; and
said first lower mating member being releasably matable to said second lower mating member when said second end of said lower strap is extended through said lower buckle.

3. The fishing rod holder device according to claim 1, further comprising:
each cup of said plurality of cups having a bottom wall and an outer wall extending upwardly from said bottom wall;
said outer wall of each cup of said plurality of cups having a top edge; and
said top edge of said outer wall of a respective one of said plurality of cups defining an opening into said respective one of said plurality of cups wherein said opening is configured to receive the handle of the respective fishing rod.

4. The fishing rod holder device according to claim 3, further comprising:
said outer wall of each cup of said plurality of cups having an interior surface;
said outer wall of each cup of said plurality of cups having a plurality of protrusions which each extends away from said interior surface; and
said plurality of protrusions associated with a respective one of said plurality of cups being evenly spaced apart from each other and being distributed around a full circumference of said interior surface wherein said plurality of protrusions associated with said respective one of said plurality of cups is configured to abut against the handle of the respective fishing rod for securing the handle of the respective fishing rod in said respective one of said plurality of cups.

5. The fishing rod holder device according to claim 4, further comprising each protrusion of said plurality of protrusions associated with a respective one of said plurality of cups extending between said bottom wall of said respective one of said plurality of cups and said top edge of said outer wall of said respective one of said plurality of cups wherein each protrusion of said plurality of protrusions associated with said respective one of said plurality of cups is configured to extend along a partial length of the handle of the respective fishing rod when the handle of the respective fishing rod is inserted into said respective one of said plurality of cups.

6. The fishing rod holder device according to claim 3, further comprising:
a plurality of cup fasteners;
each cup fastener of said plurality of cup fasteners extending through said outer wall of a respective one of said plurality of cups;
each cup fastener of said plurality of cup fasteners extending through said front surface of said lower strap; and
each cup fastener of said plurality of cup fasteners extending through said back surface of said lower strap.

7. The fishing rod holder device according to claim 6, further comprising:
a plurality of lower strap retainers;
each lower strap retainer of said plurality of lower strap retainers being positioned against said back surface of said lower strap;
each cup fastener of said plurality of cup fasteners extending through a respective one of said plurality of lower strap retainers;
each cup fastener of said plurality of cup fasteners being coupled to said respective one of said plurality of lower strap retainers;
each cup fastener of said plurality of cup fasteners attaching a respective one of said plurality of cups to a respective one of said plurality of lower strap retainers; and
each lower strap retainer of said plurality of lower strap retainers inhibiting said cup fastener which extends through a respective one of said plurality of lower strap retainers from being pulled through said lower strap.

8. The fishing rod holder device according to claim 1, further comprising:
said upper strap having a primary end and a secondary end;
said upper strap having a forward surface extending between said primary end and said secondary end;
said upper strap having a rear surface extending between said primary end and said secondary end;
an upper buckle being coupled to said primary end of said upper strap, said secondary end of said upper strap being extendable through said upper buckle;
a first upper mating member being coupled to said forward surface of said upper strap, said first upper mating member being located adjacent to said secondary end of said upper strap;
a second upper mating member being coupled to said forward surface of said upper strap, said second upper mating member being located between said first upper mating member and said primary end of said upper strap; and
said first upper mating member being releasably matable to said second upper mating member when said secondary end of said upper strap is extended through said upper buckle.

9. The fishing rod holder device according to claim 1, further comprising:
each fishing rod strap of said plurality of fishing rod straps having a coupling end and a free end;
each fishing rod strap of said plurality of fishing rod straps having a frontmost surface extending between said coupling end and said free end;
each fishing rod strap of said plurality of fishing rod straps having a rearmost surface extending between said coupling end and said free end;
each fishing rod strap of said plurality of fishing rod straps having an hole extending through said frontmost surface of a respective one of said plurality of fishing rod straps and said rearmost surface of said respective one of said plurality of fishing rod straps;
said hole associated with a respective one of said plurality of fishing rod straps being located adjacent to said free end of said respective one of said plurality of fishing rod straps;
said hole associated with a respective one of said plurality of fishing rod straps being elongated along an axis extending between said coupling end of said respective one of said plurality of fishing rod straps and said free end of said respective one of said plurality of fishing rod straps; and
said hole associated with each of said plurality of fishing rod straps having an ovoid shape.

10. The fishing rod holder device according to claim 9, further comprising:
a plurality of pins;
each pin of said plurality of pins being coupled to and extending away from said frontmost surface of a respective one of said plurality of fishing rod straps;
each pin of said plurality of pins being located adjacent to said coupling end of said respective one of said plurality of fishing rod straps;
each pin of said plurality of pins having a head;
said head of each pin of said plurality of pins being spaced from said frontmost surface of a respective one of said plurality of fishing rod straps; and
said head of said pin which is coupled to a respective one of said plurality of fishing rod straps being extendable through said hole in said respective one of said plurality of fishing rod straps such that said respective one of said plurality of fishing rod straps forms a closed loop wherein said respective one of said plurality of fishing rod straps is configured to be secured around the respective one of the plurality of fishing rods.

11. The fishing rod holder device according to claim 9, further comprising:
a plurality of fishing rod strap couplers;
each fishing rod strap coupler of said plurality of fishing rod strap couplers extending through said frontmost surface of a respective one of said plurality of fishing rod straps;
each fishing rod strap coupler of said plurality of fishing rod strap couplers extending through said rearmost surface of said respective one of said plurality of fishing rod straps;
each fishing rod strap coupler extending through said forward surface of said upper strap;
each fishing rod strap coupler of said plurality of fishing rod strap couplers extending through said rear surface of said upper strap;
each fishing rod strap coupler of said plurality of fishing rod strap couplers securing a respective one of said plurality of fishing rod straps to said forward surface of said upper strap; and
each fishing rod strap coupler of said plurality of fishing rod strap couplers being centrally located between said coupling end of a respective one of said plurality of fishing rod straps and said free end of said respective one of said plurality of fishing rod straps.

12. The fishing rod holder device according to claim 8, further comprising said plurality of fishing rod straps being evenly spaced apart from each other and being distributed between said primary end and said secondary end of said upper strap wherein each fishing rod strap of said plurality of fishing rod straps is configured to be aligned with a respective one of the plurality of fishing rods.

13. The fishing rod holder device according to claim 8, further comprising each fishing rod strap of said plurality of fishing rod straps being oriented to extend along an axis extending between said primary end of said upper strap and said secondary end of said upper strap wherein each fishing rod strap of said plurality of fishing rod straps is configured to be oriented perpendicular to the respective one of the plurality of fishing rods.

14. The fishing rod holder device according to claim 1, further comprising:
each light housing of said plurality of light housings having a front wall and a rear wall and an outside wall extending between said front wall and said rear wall;
each light of said plurality of lights being positioned on said front wall of said respective one of said plurality of light housings;
said plurality of lights associated with a respective one of said plurality of light housings being evenly spaced apart from each other and being distributed along said front wall of said respective one of said plurality of light housings.

15. The fishing rod holder device according to claim 14, further comprising:
each clip of said plurality of clips having a coupled end being coupled to said rear wall of a respective one of said plurality of light housings;
said outside wall of each light housing of said plurality of light housings having a top side;
said coupled end of each clip of said plurality of clips being aligned with said top side of said outside wall of a respective one of said plurality of light housings;
each clip of said plurality of clips extending downwardly along said rear wall of a respective one of said plurality of light housings;
each clip of said plurality of clips having a distal end with respect to said top side of said outside wall of a respective one of said plurality of light housings;
each clip of said plurality of clips having a first curve being located adjacent to said coupled end;
each clip of said plurality of clips having a second curve being located between said first curve and said distal end;
said first curve associated with each clip of said plurality of clips curving outwardly from said rear wall of a respective one of said plurality of light housings;
said second curve associated with each clip of said plurality of clips curving toward said rear wall of a respective one of said plurality of light housings; and
said distal end of each clip of said plurality of clips being directed away from said rear wall of a respective one of said plurality of light housings.

16. The fishing rod holder device according to claim 15, further comprising:
said lower strap having a topmost edge; and
said topmost edge being extendable between a respective one of said plurality of clips on a respective one of said plurality of light housings and said rear wall of said respective one of said plurality of light housings for retaining said respective one of said plurality of light housings on said forward surface of said upper strap.

17. The fishing rod holder device according to claim 15, further comprising:
said lower strap having an upper edge; and
said upper edge being extendable between a respective one of said plurality of clips on a respective of said plurality of light housings and said rear wall of said respective one of said plurality of light housings for retaining said respective one of said plurality of light housings on said front surface of said lower strap.

18. The fishing rod holder device according to claim 14, further comprising:
each light housing of said plurality of light housings including a power switch;
said power switch on a respective one of said plurality of light housings being slidably integrated into said outside wall of said respective one of said plurality of light housings; and
said power switch on said outside wall of a respective one of said plurality of light housings being in electrical communication with said plurality of lights on said respective one of said plurality of light housings for actuating or de-actuating said plurality of lights on said respective one of said plurality of light housings.

19. The fishing rod holder device according to claim 18, further comprising:
each light housing of said plurality of light housings includes a power supply;
said power supply in a respective one of said plurality of light housings being in electrical communication with said power switch on said outside wall of said respective one of said plurality of light housings;
said power supply of each light housing of said plurality of light housings including:
a rechargeable battery being positioned within a respective one of said plurality of light housings, said rechargeable battery being in electrical communication with said power switch on said outside wall of said respective one of said plurality of light housings; and
charge port being recessed into said outside wall of a respective one of said plurality of light housings wherein said charge port in said outside wall of said respective one of said plurality of light housings is configured to be electrically mated to a charge cord, said charge port in said outside wall of said respective one of said plurality of light housings being in electrical communication with said rechargeable battery in said respective one of said plurality of light housings for charging rechargeable battery in said respective one of said plurality of light housings.

20. A fishing rod holder device for securing a plurality of fishing rods for storage on a boat, said device comprising:
a boat having a pair of poles and a floor, each pole of said pair of poles being coupled to and extending upwardly from said floor, each pole of said pair of poles being vertically oriented;
a lower strap being extendable around said pair of poles, said lower strap being releasably matable to itself, said lower strap forming a closed loop extending around said pair of poles when said lower strap is releasably mated to itself, said lower strap being positionable adjacent to said floor of said boat, said lower strap having a first end and a second end, said lower strap having a front surface extending between said first end and said second end, said lower strap having a back surface extending between said first end and said second end;
a lower buckle being coupled to said first end of said lower strap, said second end of said lower strap being extendable through said lower buckle;
a first lower mating member being coupled to said front surface of said lower strap, said first lower mating member being located adjacent to said second end of said lower strap;
a second lower mating member being coupled to said front surface of said lower strap, said second lower mating member being located between said first lower mating member and said first end of said lower strap, said first lower mating member being releasably matable to said second lower mating member when said second end of said lower strap is extended through said lower buckle;
a plurality of cups, each cup of said plurality of cups being coupled to said lower strap wherein each cup of said plurality of cups is configured to insertably receive a handle of a respective one of a plurality of fishing rods, each cup of said plurality of cups lying on said floor of said boat when said lower strap is secured around said pair of poles wherein each cup of said plurality of cups is configured to orient the respective fishing rod in a vertical orientation, each cup of said plurality of cups having a bottom wall and an outer wall extending upwardly from said bottom wall, said outer wall of each cup of said plurality of cups having a top edge, said top edge of said outer wall of a respective one of said plurality of cups defining an opening into said respective one of said plurality of cups wherein said opening is configured to receive the handle of the respective fishing rod, said outer wall of each cup of said plurality of cups having an interior surface, said outer wall of each cup of said plurality of cups having a plurality of protrusions which each extends away from said interior surface, said plurality of protrusions associated with a respective one of said plurality of cups being evenly spaced apart from each other and being distributed around a full circumference of said interior surface wherein said plurality of protrusions associated with said respective one of said plurality of cups is configured to abut against the handle of the respective fishing rod for securing the handle of the respective fishing rod in said respective one of said plurality of cups, each protrusion of said plurality of protrusions associated with a respective one of said plurality of cups extending between said bottom wall of said respective one of said plurality of cups and said top edge of said outer wall of said respective one of said plurality of cups wherein each protrusion of said plurality of protrusions associated with said respective one of said plurality of cups is configured to extend along a partial length of the handle of the respective fishing rod when the handle of the respective fishing rod is inserted into said respective one of said plurality of cups;
a plurality of cup fasteners, each cup fastener of said plurality of cup fasteners extending through said outer wall of a respective one of said plurality of cups, each cup fastener of said plurality of cup fasteners extending through said front surface of said lower strap, each cup fastener of said plurality of cup fasteners extending through said back surface of said lower strap;
a plurality of lower strap retainers, each lower strap retainer of said plurality of lower strap retainers being positioned against said back surface of said lower strap, each cup fastener of said plurality of cup fasteners extending through a respective one of said plurality of lower strap retainers, each cup fastener of said plurality of cup fasteners being coupled to said respective one of said plurality of lower strap retainers, each cup fastener of said plurality of cup fasteners attaching a respective one of said plurality of cups to a respective one of said plurality of lower strap retainers, each lower strap retainer of said plurality of lower strap retainers inhibiting said cup fastener which extends through a respective one of said plurality of lower strap retainers from being pulled through said lower strap;
an upper strap being extendable around said pair of poles in said boat, said upper strap being releasably matable to itself, said upper strap forming a closed loop extending around said pair of poles when said upper strap is releasably mated to itself, said upper strap being spaced upwardly from said lower strap on said pair of poles, said upper strap having a primary end and a secondary end, said upper strap having a forward surface extending between said primary end and said secondary end, said upper strap having a rear surface extending between said primary end and said secondary end;
an upper buckle being coupled to said primary end of said upper strap, said secondary end of said upper strap being extendable through said upper buckle;
a first upper mating member being coupled to said forward surface of said upper strap, said first upper mating member being located adjacent to said secondary end of said upper strap;
a second upper mating member being coupled to said forward surface of said upper strap, said second upper mating member being located between said first upper mating member and said primary end of said upper strap, said first upper mating member being releasably matable to said second upper mating member when said secondary end of said upper strap is extended through said upper buckle;
a plurality of fishing rod straps, each fishing rod strap of said plurality of fishing rod straps being coupled to said upper strap wherein each fishing rod strap of said plurality of fishing rod straps is configured to be wrapped around a respective one of the plurality of fishing rods to secure the respective one of the plurality of fishing rods to said upper strap, each fishing rod strap of said plurality of fishing rod straps having a coupling end and a free end, each fishing rod strap of said plurality of fishing rod straps having a frontmost surface extending between said coupling end and said free end, each fishing rod strap of said plurality of fishing rod straps having a rearmost surface extending between said coupling end and said free end, each fishing rod strap of said plurality of fishing rod straps having an hole extending through said frontmost surface of a respective one of said plurality of fishing rod straps and said rearmost surface of said respective one of said plurality of fishing rod straps, said hole associated with a respective one of said plurality of fishing rod straps being located adjacent to said free end of said respective one of said plurality of fishing rod straps, said hole associated with a respective one of said plurality of fishing rod straps being elongated along an axis extending between said coupling end of said respective one of said plurality of fishing rod straps and said free end of said respective one of said plurality of fishing rod straps, said hole associated with each of said plurality of fishing rod straps having an ovoid shape;
a plurality of pins, each pin of said plurality of pins being coupled to and extending away from said frontmost surface of a respective one of said plurality of fishing rod straps, each pin of said plurality of pins being located adjacent to said coupling end of said respective one of said plurality of fishing rod straps, each pin of said plurality of pins having a head, said head of each pin of said plurality of pins being spaced from said frontmost surface of a respective one of said plurality of fishing rod straps, said head of said pin which is coupled to a respective one of said plurality of fishing rod straps being extendable through said hole in said respective one of said plurality of fishing rod straps such that said respective one of said plurality of fishing rod straps forms a closed loop wherein said respective one of said plurality of fishing rod straps is configured to be secured around the respective one of the plurality of fishing rods;
a plurality of fishing rod strap couplers, each fishing rod strap coupler of said plurality of fishing rod strap couplers extending through said frontmost surface of a respective one of said plurality of fishing rod straps, each fishing rod strap coupler of said plurality of fishing rod strap couplers extending through said rearmost surface of said respective one of said plurality of fishing rod straps, each fishing rod strap coupler extending through said forward surface of said upper strap, each fishing rod strap coupler of said plurality of fishing rod strap couplers extending through said rear surface of said upper strap, each fishing rod strap coupler of said plurality of fishing rod strap couplers securing a respective one of said plurality of fishing rod straps to said forward surface of said upper strap, each fishing rod strap coupler of said plurality of fishing rod strap couplers being centrally located between said coupling end of a respective one of said plurality of fishing rod straps and said free end of said respective one of said plurality of fishing rod straps, said plurality of fishing rod straps being evenly spaced apart from each other and being distributed between said primary end and said secondary end of said upper strap wherein each fishing rod strap of said plurality of fishing rod straps is configured to be aligned with a respective one of the plurality of fishing rods, each fishing rod strap of said plurality of fishing rod straps being oriented to extend along an axis extending between said primary end of said upper strap and said secondary end of said upper strap wherein each fishing rod strap of said plurality of fishing rod straps is configured to be oriented perpendicular to the respective one of the plurality of fishing rods;
a plurality of light housings, each light housing of said plurality of light housings having a front wall and a rear wall and an outside wall extending between said front wall and said rear wall;
a plurality of lights, each light of said plurality of lights being coupled to a respective one of said plurality of light housings wherein each light of said plurality of lights is configured to emit light outwardly from said respective one of said plurality of light housings to illuminate said boat when the boat is in a darkened environment, each light of said plurality of lights being positioned on said front wall of said respective one of said plurality of light housings, said plurality of lights associated with a respective one of said plurality of light housings being evenly spaced apart from each other and being distributed along said front wall of said respective one of said plurality of light housings;
a plurality of clips, each clip of said plurality of clips being coupled to a respective one of said plurality of light housings, each clip of said plurality of clips being removably attachable to a respective one of said upper strap or said lower strap, each clip of said plurality of clips retaining a respective one of said plurality of light housings to a respective one of said upper strap or said lower strap, each clip of said plurality of clips having a coupled end being coupled to said rear wall of a respective one of said plurality of light housings, said outside wall of each light housing of said plurality of light housings having a top side, said coupled end of each clip of said plurality of clips being aligned with said top side of said outside wall of a respective one of said plurality of light housings, each clip of said plurality of clips extending downwardly along said rear wall of a respective one of said plurality of light housings, each clip of said plurality of clips having a distal end with respect to said top side of said outside wall of a respective one of said plurality of light housings, each clip of said plurality of clips having a first curve being located adjacent to said coupled end, each clip of said plurality of clips having a second curve being located between said first curve and said distal end, said first curve associated with each clip of said plurality of clips curving outwardly from said rear wall of a respective one of said plurality of light housings, said second curve associated with each clip of said plurality of clips curving toward said rear wall of a respective one of said plurality of light housings, said distal end of each clip of said plurality of clips being directed away from said rear wall of a respective one of said plurality of light housings, said lower strap having a topmost edge, said topmost edge being extendable between a respective one of said plurality of clips on a respective one of said plurality of light housings and said rear wall of said respective one of said plurality of light housings for retaining said respective one of said plurality of light housings on said forward surface of said upper strap, said lower strap having an upper edge, said upper edge being extendable between a respective one of said plurality of clips on a respective of said plurality of light housings and said rear wall of said respective one of said plurality of light housings for retaining said respective one of said plurality of light housings on said front surface of said lower strap;
wherein each light housing of said plurality of light housings includes a power switch, said power switch on a respective one of said plurality of light housings being slidably integrated into said outside wall of said respective one of said plurality of light housings, said power switch on said outside wall of a respective one of said plurality of light housings being in electrical communication with said plurality of lights on said respective one of said plurality of light housings for actuating or de-actuating said plurality of lights on said respective one of said plurality of light housings;
wherein each light housing of said plurality of light housings includes a power supply, said power supply in a respective one of said plurality of light housings being in electrical communication with said power switch on said outside wall of said respective one of said plurality of light housings, said power supply of each light housing of said plurality of light housings including:
a rechargeable battery being positioned within a respective one of said plurality of light housings, said rechargeable battery being in electrical communication with said power switch on said outside wall of said respective one of said plurality of light housings; and
charge port being recessed into said outside wall of a respective one of said plurality of light housings wherein said charge port in said outside wall of said respective one of said plurality of light housings is configured to be electrically mated to a charge cord, said charge port in said outside wall of said respective one of said plurality of light housings being in electrical communication with said rechargeable battery in said respective one of said plurality of light housings for charging rechargeable battery in said respective one of said plurality of light housings.
